(19) United States
(12) Patent Application Publication
(10) Pub. No.: US 2008/0203207 A1
(43) Pub. Date: Aug. 28, 2008

(54) LINE HOLDER

(75) Inventors: Konrad L. Krauland, Grand Junction, CO (US); Brett S. Hensley, Grand Junction, CO (US); Jarrett Edwards, Page, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Innovative Textiles, Inc.

(21) Appl. No.: 12/036,549

(22) Filed: Feb. 25, 2008

Related U.S. Application Data
(60) Provisional application No. 60/903,421, filed on Feb. 26, 2007.

(51) Int. Cl. A01K 89/02; A01K 89/00

(52) U.S. Cl. 242/287; 242/322

(57) ABSTRACT

A line holder includes a spool about which line is wound and a spool housing. The spool is rotatably supported in the housing. The spool housing has an aperture through which the line is extendable. The spool housing includes a member that applies a variable force to the spool to resist rotation of the spool relative to the spool housing. A cutter may be connected to the spool housing for cutting the line. A method of providing fishing line is also disclosed.

### RELATED APPLICATION

This application claims priority from U.S. Provisional Application No. 60/903,421, filed 26 Feb. 2007, the subject matter of which is incorporated herein by reference.

### TECHNICAL FIELD

The present invention relates to a line holder and a method for use of the line holder and, more particularly, to a fishing line holder.

### BACKGROUND OF THE INVENTION

Fishing line, such as monofilament fishing line, is commonly used by fishermen with a fishing rod and reel. The fishing line may be sold separately from the fishing rod and reel, and in a predetermined quantity, such as in a 300-yard spool. Two people are needed to wind the fishing line onto a fishing reel. One must hold and apply tension to the spool of fishing line as another person winds the fishing line onto the reel. Furthermore, the fisherman may wish to use less than the entire spool at one time. However, a partially used spool tends to unravel within the fisherman's tackle box. Moreover, a fisherman wishing to use only a partial spool must provide a separate cutting instrument to cut the desired length of fishing line.

### SUMMARY OF THE INVENTION

In an embodiment of the present invention, a line holder is described. The line holder includes a spool about which line is wound and a spool housing. The spool is rotatably supported in the housing. The spool housing has an aperture through which the line is extendable. The spool housing includes a friction member that transfers a variable force to the spool to variably resist rotation of the spool relative to the spool housing.

In an embodiment of the present invention a method of providing fishing line is described. A spool is wound with a predetermined amount of fishing line and a loose end of the fishing line is allowed to extend from the spool. A spool housing is provided, the spool housing including a first housing panel defining a panel perimeter and a housing side wall extending from the panel perimeter, the first housing panel and the housing side wall cooperatively defining a chamber for receiving the spool. The spool is inserted into the spool housing. The spool is rotatably supported within the spool housing. The spool is retained within the spool housing. The loose end of the fishing line is guided through an aperture in the spool housing. The spool is rotated within the spool housing to unwind fishing line as the fishing line is pulled through the aperture. Tension of the unwound fishing line is controlled by controlling rotation of the spool. The tension is controlled by bringing the spool into direct frictional engagement with at least a portion of the spool housing to help control rotation of the spool.

### BRIEF DESCRIPTION OF THE DRAWINGS

For a better understanding of the invention, reference may be made to the accompanying drawings, in which:

FIG. 1 is a perspective front view of one embodiment of the present invention in a first configuration;

FIG. 1A is a perspective front view of the embodiment of FIG. 1 in a second configuration;

FIG. 2 is an exploded perspective front view of the embodiment of FIG. 1;

FIG. 3 is a perspective rear view of the embodiment of FIG. 1;

FIG. 4 is a perspective front view of another embodiment of the present invention;

FIG. 5 is an exploded perspective front view of the embodiment of FIG. 4;

FIG. 6 is a perspective rear view of the embodiment of FIG. 4.

### DESCRIPTION OF EMBODIMENTS

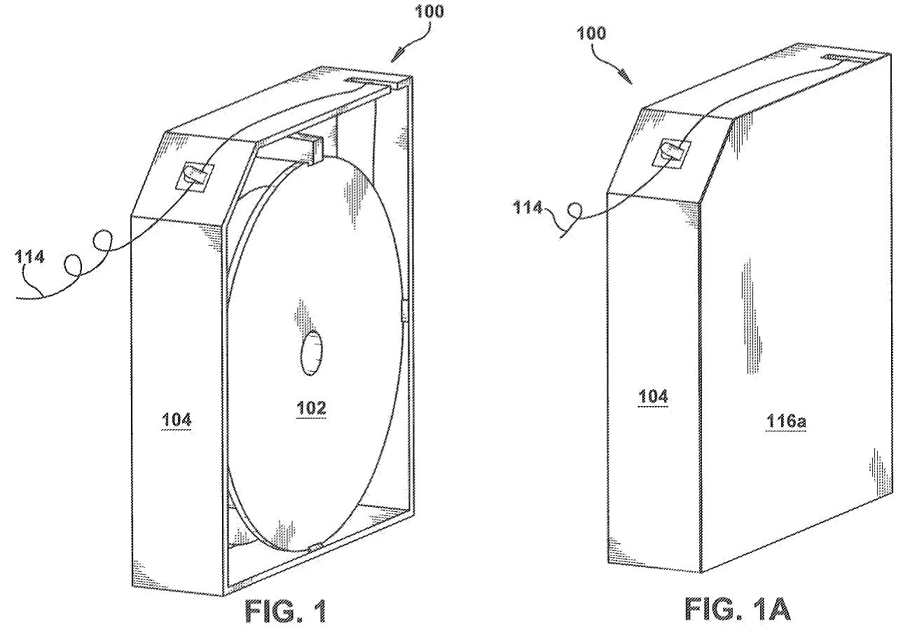

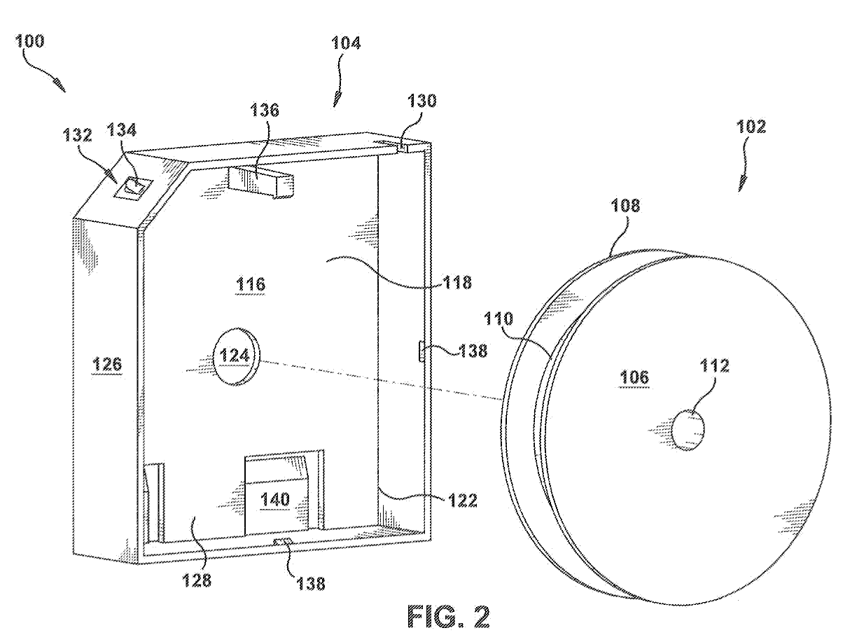

In accordance with a first embodiment of the present invention, FIG. 1 depicts a fishing line holder 100 in a first configuration. The fishing line holder 100 includes a spool 102 and a spool housing 104. The spool 102 is rotatably supported in the housing 104. The spool 102 and spool housing 104 are shown in more detail in FIG. 2.

The spool 102 includes first and second spool flanges 106 and 108, respectively, laterally separated by a spool body 110. At least one of the first and second spool flanges 106 and 108 has a larger diameter than the spool body 110. The spool 102 may also include a center spool opening 112. Line 114, such as fishing line or monofilament line, is wound around the spool body 110 for storage and dispensing.

The spool housing 104 includes a housing panel or member 116 having oppositely disposed first and second panel sides 118 and 120, respectively. The panel or member 116 may be flexible. A panel perimeter 122 defines an outer edge of the housing panel or member 116 and laterally separates the first and second panel sides 118 and 120. The housing panel or member 116 may include a housing opening 124 axially aligned with the spool opening 112. The spool housing 104 is shown and described herein as having a rectangular solid form factor, but could have any suitable form factor, including but not limited to a cubic, cylindrical, spherical, curvilinear, teardrop, or polyhedral shape.

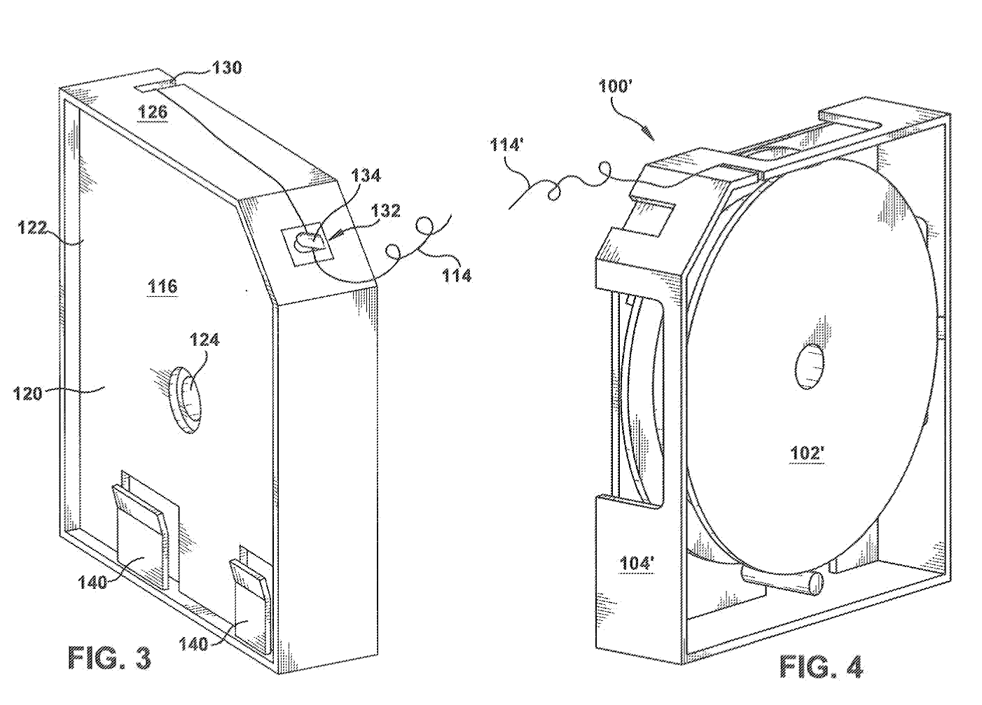

A housing side wall 126 extends from the panel perimeter 122 adjacent the first panel side 118. The housing side wall 126 substantially extends in a direction away from the first panel side 118. A portion of the housing side wall 126 may also be located adjacent, and extend away from, the second panel side 120, as shown in FIG. 3. The housing side wall 126 may extend from the first and second panel sides 118 and 120 any desired distance. The housing side wall 126 may extend from the first panel side 118 a distance slightly greater than the distance between the first and second spool flanges 106 and 108. The housing side wall 126 and the housing panel or member 116 define a chamber 128 for receiving the spool 102.

As shown in the second configuration of FIG. 1A, a second housing panel or member 116a may be attached to all or part of the housing side wall 126 in a position spaced from the housing panel or member 116. The second housing panel or member 116a, when present, may be operative to at least partially cover the spool 102 within the housing side wall 126 in the assembled fishing line holder 100. The second housing panel or member 116a may be flexible, semi-rigid, or rigid and may be attached to the housing side wall 126 in any desired manner. For example, the second housing panel or member 116a may be a self-adhesive label or a snap-fit plastic sheet. The housing side wall 126, or another appropriate structure of the fishing line holder 100 to which the second housing panel or member 116a is connected, may include any modifications or additional structures desired to help attach the second housing panel or member to the housing side wall.

The housing side wall 126 or another structure of the spool housing 104 may include a slot, hole, or other aperture 130 through which the fishing line 114 can extend. The aperture 130 may be located in any desired portion of the side wall 126. The aperture 130 guides the fishing line 114 during unwinding of the fishing line from the spool 102. An adhesive area or frictional retention notch (not shown) may be provided on an outer surface of the housing side wall 126 adjacent to the aperture 130 to assist in retaining a loose end of the fishing line 114.

The housing side wall 126 or another structure of the spool housing 104 may include a cutter 132, either integrally formed therewith or separately provided and attached thereto. The cutting tab 134 shown in FIGS. 1-3 is cut from, and bent away from, the spool housing 104. The cutting tab 134 has an edge which is sufficiently sharp to sever the fishing line 114 when the user scrapes or pulls the fishing line past the edge. Optionally, the cutter 132 is designed to retain a loose end of the fishing line 114 extending from the aperture 130 after the fishing line has been cut. The cutter 132 may be of any suitable type, either unitary one-piece or including multiple components, and may be sharpened and/or serrated as desired to cut the fishing line 114.

The spool housing 104 may include a spool retainer. As shown in FIGS. 1 and 2, the spool retainer may include a retention arm 136 and one or more retention members 138. The retention arm 136 may have a cantilevered structure with a hook end, as shown in FIG. 2. The retention arm 136 may extend from the panel or member 116. The spool retainer is adapted to hold the spool 102 within the housing side wall 126 while allowing the spool 102 to rotate with respect to the spool housing 104. The spool 102 can then rotate with respect to the spool housing 104 to allow the fishing line 114 to unwind from the spool 102. The retention members 138 may extend from the housing side wall 126. The retention arm 136 and retention members 138 may engage one of the flanges 106, 108 of the spool 102 to retain the spool in the chamber 128 in the housing 104. The retention arm 136 and retention members 138 support the spool 102 for rotation relative to the housing 104.

When at least one of the center spool opening 112 and the housing opening 124 is provided, and regardless of the presence of the retention arm 136 and/or retention members 138, the spool retainer may take the form of an axle-and-hub mechanism. Namely, at least one of the spool 102 and spool housing 104 may include a protruding axle, or a separate axle (not shown) could be provided to the fishing line holder 100.

The spool housing 104 optionally includes at least one clip 140, with two clips 140 shown in FIG. 3. The clips 140 could be integrally formed with at least one of the housing panel or member 116 and the housing side wall 126 (as shown). Alternately, the clips 140 may be separately provided and connected to the housing 104 in any desired manner. The clips 140 are adapted to retain a printed sheet (not shown) of product literature or other labeling or information adjacent the second panel side 120 on the outside of the spool housing 104. The clips 140 may also or instead retain a strip of mounting or arbor tape (not shown) adjacent the second panel side 120. The mounting or arbor tape, when present, is used to tape an end of the fishing line 114 to a reel for winding the fishing line on the reel from the line holder 100. The clips 140 may retain the printed sheet and/or the tape through frictional engagement with the sheet or merely through preventing the sheet or tape from falling away from the second panel side 120. Optionally, these clips 140 and/or other retention means may be provided for holding or attaching other accessory items to the housing 104, such as hooks, hook sharpeners, or other items (not shown).

To assemble the fishing line holder 100, the spool body 110 is first wound with a predetermined amount of fishing line 114. The spool 102 is then positioned in the orientation shown in FIG. 2, with the center spool opening 112 and the housing opening 124 aligned with each other, and inserted into the spool housing 104. It is contemplated that the fishing line holder 100 may be manufactured and sold integrally as a single item, or that the spool 102 and/or spool housing 104 may be provided separately and assembled by a retailer, end user, or other party.

When the first and/or second spool flange 106 or 108 engages the retention arm 136, the cantilevered end of the retention arm flexes away from the spool 102 to permit passage of the spool. The retention arm 136 then returns to a resting position, thus holding the spool 102 in place within the spool housing 104, with the second spool flange 108 located adjacent the first panel side 118.

Once the spool 102 is held within the spool housing 104, the loose end of the fishing line 114 may be guided to the outside of the housing side wall 126 through the aperture 130. The fishing line 114 is optionally brought into engagement with the cutter 132 or another retention device to allow the end user to readily access the loose end of the fishing line. The second housing panel or member 116a may then be attached to the housing side wall 126 in any desired manner.

After assembly as above, a printed sheet (not shown), such as a product label, may be held adjacent the second panel side 120 by one or more clips 140. A strip of mounting or arbor tape may also or instead be held adjacent the second panel side 120 by one or more clips 140. Whether or not the printed sheet and/or tape is provided, the fishing line holder 100 is in an assembled state and is ready to store and/or dispense fishing line 114 as desired.

Once assembled, the fishing line holder 100 may be provided to a user. The user may feed the fishing line 114 through the aperture 130, if needed, and then may pull a desired length of fishing line from the spool 102 and cut the fishing line using the cutter 132. A single user may secure the fishing line holder 100 while the fishing line 114 is being wound onto a reel. For instance, the user may grip the fishing line holder 100 between his knees, fingers, or other body parts, or between a foot or other body part and a nearby surface while drawing fishing line 114 out from the spool housing 104. If the user grips the fishing line holder 100 using a lateral force, the gripping force exerted may move one or both of the housing panels or members 116, 116a into engagement with the spool flanges 106, 108 of the spool 102. The user may control rotation of the spool 102 through direct frictional engagement between the spool 102 and the spool housing 104. The user may apply a variable force to the spool 102 to resist rotation of the spool relative to the spool housing 104. For example, the spool 102 may directly frictionally engage at least one of the housing panel or member 116 and the second housing panel or member 116a to help control rotation of the spool 102. The flexibility of at least one of the housing panel or member 116 and the second housing panel or member 116a may be configured to transfer a variable force applied on the spool housing 104 to the spool 102 in a desired manner. The user may exert and change the force exerted on the fishing line holder 100 (and transferred to the spool 102 by at least one component of the spool housing 104) nearly instantaneously as needed during removal of the fishing line 114 from the spool 102. The tension of the fishing line 114 can thus be relatively finely controlled with a simple, intuitive squeezing motion by the user, and no structural modification to the fishing line holder 100 to decrease or increase tension, other than a slight lateral flexing, is needed. The fishing line 114 unwinding from the spool 102 may thereby be placed under tension by a user as desired, as unwinding is occurring and without the assistance of another user.

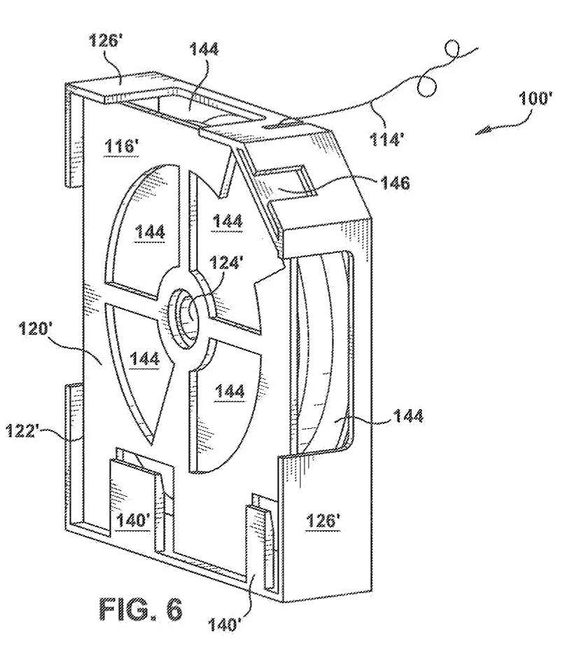

FIGS. 4-6 depict a fishing line holder 100′ according to a second embodiment of the present invention. The fishing line holder 100′ of FIGS. 4-6 is similar to the fishing line holder of FIGS. 1-3 and therefore, structures of FIGS. 4-6 that are the same as or similar to those described with reference to FIGS. 1-3 have the same reference numbers with the addition of a prime. Description of common elements and operation similar to those in the previously described first embodiment will not be repeated with respect to the second embodiment.

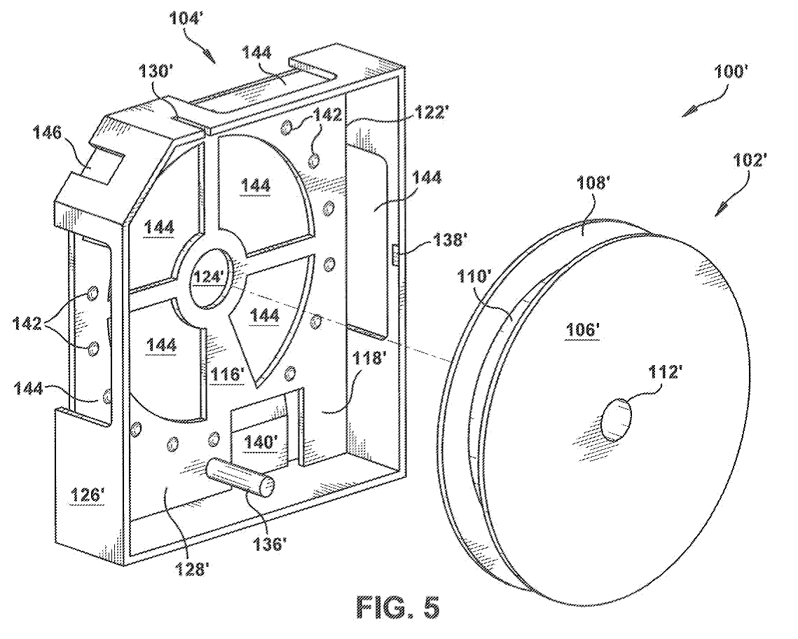

The spool housing 104′ of the second embodiment may include one or more passive retention members 136′. Instead of the active cantilevered beam of the first embodiment, the retention member 136′ of the second embodiment is sized and positioned to align the center spool opening 112′ with the housing opening 124′ when the fishing line holder 100′ is assembled. The retention member 136′ may be used for passively guiding a position of the spool 102′ within the spool housing 104′, rather than for snapping the spool into the housing as in the first embodiment. The retention member 136′ supports the spool in a sliding contact relationship when the spool turns within the spool housing. Alternatively, the retention member 136′ may include a rotatable portion in contact with the spool 102′, to reduce drag on the rotating spool during withdrawal of fishing line 114′ At least one spacing nub 142, as shown in FIG. 5, may be provided to hold the spool 102′ away from the first panel side 118′ of the housing panel or member 116′. Any number, orientation, shape, or arrangement of spacing nubs 142 may be provided, on any surface of the spool 102′ or spool housing 104′ as desired. Spacing nubs 142 may also or instead be provided on a second housing panel or member (not shown). The second housing panel or member may be generally similar to the second housing panel or member 116a, illustrated in FIG. 1A.

The spacing nubs 142 may be formed integrally with a component of the fishing line holder 100′ or 100 of any embodiment of the present invention, or may be provided separately, and may be made of any desired material. The spacing nubs 142, when present, may selectively act both to space the spool 102′ from the spool housing 104′ and to provide a reduced area (as compared to that of the first embodiment) of frictional contact between the spool flanges 106′, 108′ of the spool and the spool housing. The spacing nubs 142 on the housing panels or members may move into direct engagement with the spool 102′ when a lateral force is applied upon the opposite side of the housing panels or member, with the spacing nubs thus acting as friction members and transferring the lateral force from the user to the spool. The user may therefore exert a desired amount of readily variable control over rotation of the spool 102′ when exerting a laterally oriented force on the fishing line holder 100′ to tension the fishing line 114′.

One or more viewports 144 may be provided in the spool housing 104′. The viewports 144, when present, may be transparent portions inserted into the material forming the spool housing 104′ or may be merely voids in the spool housing, and may be of any number, orientation, shape, or arrangement. The viewports 144 may allow visual inspection of the spool 102′ and/or fishing line 114′ within the spool housing 104′. The viewports 144, when of the void type, may also allow the spool housing 104′ to be made with less material, for cost and/or weight savings.

The fishing line holder 100′ of the second embodiment includes a cutter recess 146 adapted to hold a separately provided cutter (not shown). The cutter recess 146 may be readily designed to accept and retain the cutter in a desired manner, and facilitates provision of a cutter made from a material, such as a metal, which is different from the material of the spool housing 104′, such as a plastic. In the depicted embodiment, a plate with a protruding cutting edge (not shown) may be laterally slid into the cutter recess 146. The cutter recess 146 may be adapted to accept a cutter in a permanent manner, such as through a tight frictional fit, perhaps aided by a non-reversible mounting structure/process, or by the use of adhesives. Alternately or additionally, the cutter recess 146 may be adapted for temporary engagement with a cutter through, for example, a loose frictional fit or a reversible mounting structure/process. Such a temporary mounting of the cutter in the cutter recess 146 may be particularly useful when the spool housing 104′ is intended for repeated use with multiple spools 102′. In such an application, the cutter is liable to dull over time and it may be desirable to provide replacement cutters. A cutter may be connected to a spool housing 104′ of any embodiment of the present invention in any desired manner.

While aspects of the present invention have been particularly shown and described with reference to the preferred embodiments above, it will be understood by those of ordinary skill in the art that various additional embodiments may be contemplated without departing from the spirit and scope of the present invention. For example, any of the structures of the fishing line holder 100, 100′ may be made of any suitable material or combination of materials. The spool housing 104, 104′ could be designed to simultaneously hold and dispense fishing line from a plurality of spools 102, 102′, with the spools located laterally adjacent one another inside the spool housing. Multiple clips 140, 140′ need not be matched in size, shape, position, orientation, or any other aspect. The retention member 136, 136′ may include both active and passive features to support and/or retain the spool 102, 102′ as desired. A device or method incorporating any of these features should be understood to fall under the scope of the present invention as determined based upon the claims below and any equivalents thereof.

Other aspects, objects, and advantages of the present invention can be obtained from a study of the drawings, the disclosure, and the appended claims.

Having described the invention, I claim:

1. A line holder, comprising:
a spool about which line is wound; and
a spool housing, the spool being rotatably supported in the spool housing, the spool housing having an aperture through which the line is extendable, the spool housing including a friction member that transfers a variable force to the spool to variably resist rotation of the spool relative to the spool housing.

2. The line holder of claim 1, including a cutter connected to the spool housing for cutting the line.

3. The line holder of claim 1, wherein the friction member is a housing panel defining a chamber receiving the spool.

4. The line holder of claim 1, wherein the friction member is a flexible portion of the spool housing.

5. The line holder of claim 1, wherein the friction member includes a nub engageable with the spool.

6. The line holder of claim 1, wherein the spool housing includes at least one viewport.

7. The line holder of claim 1, wherein the spool housing includes a first housing panel defining a panel perimeter and a housing side wall extending from the panel perimeter, the first housing panel and the housing side wall cooperatively defining a chamber for receiving the spool.

8. The line holder of claim 7, including a second housing panel connected to the panel perimeter at a location spaced apart from the first housing panel, and the first housing panel, the second housing panel, and the housing side wall cooperatively defining the chamber.

9. The line holder of claim 7, wherein a spool retainer extends from the housing side wall to retain the spool in the housing.

10. The line holder of claim 7, wherein a retention arm extends from the first housing panel to retain the spool in the housing.

11. The line holder of claim 7, wherein the first housing panel includes an opening axially aligned with an opening extending through the spool.

12. The line holder of claim 7, wherein the first housing panel is flexible to transfer the variable force to the spool.

13. A method of providing fishing line, the method comprising the steps of:
winding a spool with a predetermined amount of fishing line and allowing a loose end of the fishing line to extend from the spool;
providing a spool housing including a first housing panel defining a panel perimeter and a housing side wall extending from the panel perimeter, the first housing panel and the housing side wall cooperatively defining a chamber for receiving the spool;
inserting the spool into the spool housing;
rotatably supporting the spool within the spool housing;
retaining the spool within the spool housing;
guiding the loose end of the fishing line through an aperture in the spool housing;
rotating the spool within the spool housing to unwind fishing line as the fishing line is pulled through the aperture; and
controlling tension of the unwound fishing line by controlling rotation of the spool, wherein the tension is controlled by bringing the spool into direct frictional engagement with at least a portion of the spool housing to help control rotation of the spool.

14. The method of claim 13, wherein the step of bringing the spool into frictional engagement with at least a portion of the spool housing to help control rotation of the spool includes the steps of:
providing at least one friction member on the spool housing; and
selectively engaging the spool with the at least one friction member.

15. The method of claim 13, including the step of cutting the fishing line with a cutter connected to the spool housing.

16. The method of claim 13, including the step of retaining the loose end of the fishing line at a predetermined location on the spool housing.
